(19) United States
(12) Patent Application Publication
(10) Pub. No.: US 2008/0228859 A1
(43) Pub. Date: Sep. 18, 2008

(54) Grid Computing System for Testing Application Program Capacity of Server

(75) Inventor: Kye-Kwan Kim, Daejeon (KR)

Correspondence Address: GREENBLUM & BERNSTEIN, P.L.C., 1950 ROLAND CLARKE PLACE, RESTON, VA, 20191, US

(73) Assignee: GRIDONE, CO. LTD, Daejeon (KR)

(21) Appl. No.: 11/718,066

(22) PCT Filed: Nov. 28, 2006
(86) PCT No.: PCT/KR2006/005043

§ 371 Date: Apr. 26, 2007

(30) Foreign Application Priority Data
Nov. 29, 2005 (KR) 10- 2005-0114912

(51) Int. Cl. G06F 15/16

(52) U.S. Cl. 709/202

(57) ABSTRACT

Disclosed is a grid computing system for testing the application program capacity of a server. The system includes an application server having an application program installed therein; a number of user clients having a capacity measurement program installed therein, the user clients applying a load, which contains a scenario, to the application program so as to create capacity measurement data regarding the application server; and a capacity measurement server for distributing a capacity measurement program to the user clients so as to transmit a load command, the capacity measurement server collecting the capacity measurement data created by the user clients and analyzing the capacity measurement data. The system creates loads as requests expected from actual users and uses them for the test so as to guarantee the stability of a developed system by anticipating problems which are likely to occur when the system is operated.

### TECHNICAL FIELD

The present invention relates to a grid computing system for testing the application program capacity of a server. More particularly, the present invention relates to a grid computing system for testing the application program capacity of a server, wherein PCs, which are in connection with a capacity measurement server via Internet, are used to measure the application program capacity of an application server established in a company.

### BACKGROUND ART

FIG. 1 shows the construction of a conventional system for providing an Internet service. The system includes routers 20, a gateway 30, and an application server 40. An application program is installed in the application server 40 so as to provide the service. In order to measure the application program, 10-20 PCs are used to create a number of virtual users for each PC.

The conventional system has a problem in that, since a single client is used, the number of processes and threads the operating system can create is limited. This means that the creation of virtual users is restricted. Furthermore, it is difficult to measure the actual capacity based on loads regarding those who have accessed during actual operation, as well as on the network condition of respective regions, because the system depends on the scheduling of processes and threads of the operating system.

### DISCLOSURE

### Technical Problem

Therefore, the present invention has been made in view of the above-mentioned problems, and it is an object of the present invention to provide a grid computing system for testing the application program capacity of a server, wherein loads are created as requests expected from actual users and are used for the test so as to guarantee the stability of a developed system by anticipating problems which are likely to occur when the system is operated.

### Technical Solution

In order to accomplish this object, according to an aspect of the present invention, there is provided a grid computing system for testing an application program capacity of a server, the grid computing system including an application server having an application program installed therein; a number of user clients having a capacity measurement program installed therein, the user clients applying a load, the load containing a scenario, to the application program so as to create capacity measurement data regarding the application server; and a capacity measurement server for distributing a capacity measurement program to the user clients so as to transmit a load command, the capacity measurement server collecting the capacity measurement data created by the user clients and analyzing the capacity measurement data.

The grid computing system further includes an administrator server for inputting commands to the capacity measurement server and displaying a capacity condition of the application server.

The capacity measurement server and the user clients exchange the capacity measurement data as a message.

The user clients are adapted to provide the capacity measurement server with the capacity measurement data based on a grid technique.

The user clients are adapted to conduct capacity measurement by using one of a PC, a PDA, a mobile telephone, and a terminal equipped with an Internet device and a computation device.

The capacity measurement data is created by a PC or a group of PCs establishing a small-scale network.

The user clients and the application server communicate with each other by using one of HTTP, SQL, XML, TCP/UDP/IP, SIP, and RTP according to the application program of the application server.

The capacity measurement server includes a user interface process for interworking with the administrator client and receiving an execution command; a client management process for managing the user clients so as to receive the execution command from the user interface process and conduct capacity measurement; a message management process for receiving the capacity measurement data from the user clients, the user clients conducting capacity measurement, the message management process collecting and analyzing the capacity measurement data, the message management process composing a result report automatically; and a communication process for receiving the capacity measurement data from the user clients.

Each user client includes a communication process for interworking with the capacity measurement server; and a command process for transmitting the capacity measurement data to the communication process, the capacity measurement data having been collected from the application server by the capacity measurement server.

The application server is adapted to handle connection requests of clients, data processing, and client management, and the application server is a measurement target selected from a WAS, a softswitch, a media server, a game server, a network management system server, and a DB server.

### ADVANTAGEOUS EFFECTS

The grid computing system for testing the application program capacity of a server according to the present invention is advantageous in that, based on an anticipation that many problems will result from actual users requests, the system creates loads as requests expected from the users and measures the capacity. Therefore, the inventive system can be used as a tool for estimating the capacity of an application system which is being developed, as well as a tool for checking the execution logic. This prevents problems from occurring after the system is completed and operated, and reduces the burden of trial and error and related expenditures.

### DESCRIPTION OF DRAWINGS

FIG. 1 shows the construction of a conventional system for providing an Internet service;

FIG. 2 shows the construction of a grid computing system for testing the application program capacity of a server according to the present invention; and

FIG. 3 shows the construction of a system implementing a capacity measurement server and user clients according to the present invention.

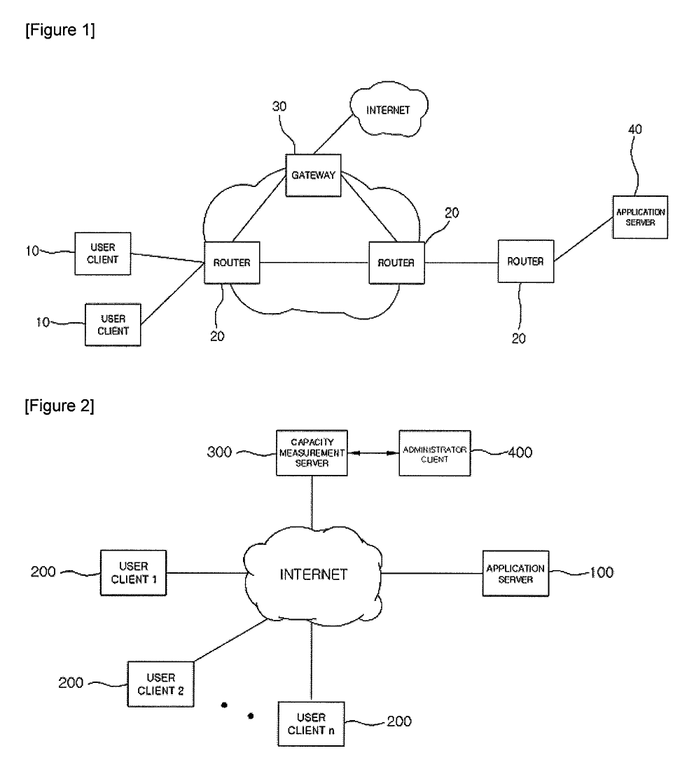

### MODE FOR INVENTION

Reference will now be made in detail to the preferred embodiments of the present invention.

FIG. 2 shows the construction of a grid computing system for testing the application program capacity of a server according to the present invention. The system establishes a network including an application server 100, a number of user clients 200, a capacity measurement server 300, and an administrator client 400. The capacity measurement server 300 analyzes the capacity of the application server 100 by collecting data resulting from analysis of resources and processing rate of the application server 100, which have been measured by the user clients 200.

More particularly, the application server 100 has an application program (i.e. test target) installed therein and provides the user clients 200 with a service based on the application program. The application server 100 receives requests for the service from the user clients 200 according to a procedure and a method specified by a script. As used herein, the script is a kind of load for testing the capacity of the application server 100, and contains a scenario including a log-in step, a step of moving to a bulletin board after the log-in step, and a download step.

The user clients 200 have a capacity measurement program installed therein, which is used to measure the application program capacity of the application server 100. By using the capacity measurement program, the user clients 200 receive a script and a command to execute the script. The capacity measurement program is downloaded from the capacity measurement server 300 to be executed and installed. The command to execute the script is inputted by the administrator server 400, which controls the capacity measurement server 300, and is then executed.

Upon receiving the script, the user clients 200 execute a series of steps according to the scenario contained in the script. Particularly, the user clients 200 log into the application server 100, make use of the bulletin board, and download desired materials. Then, the user clients 200 collect the resulting information regarding the execution. This procedure will be described in more detail with reference to Table 1 below.

TABLE 1

| | | | Speed of movement to |
|---|---|---|---|
| | Access condition | Response time | bulletin board |
| Client A | Ok | 100 ms | 50 ms |
| Client B | Ok | 80 ms | 40 ms |
| Client C | No | — | — |

It is clear from Table 1 that client A, after accessing the application server 100 and executing the script, is in a log-in condition and has a response time of 100 ms and a speed of movement to the bulletin board of 50 ms. Similarly, the client B is in a log-in condition and has a response time of 80 ms and a speed of movement to the bulletin board of 40 m. The data created by clients A and B is transmitted to the capacity measurement server 300. In the case of client C of Table 1, it has not logged into the application server 100, and there is no relevant data. Therefore, data indicating that client C has not logged in is transmitted to the capacity measurement server 300. As such, the capacity measurement server 300 collects data from the clients.

The user clients 200 may be PCs used by individuals, as well as a group of PCs establishing a small-scale network, most preferably, an Internet cafe'

In summary, each user client 200 accesses the application server 100 and creates data regarding the capacity test. The data is transmitted to the capacity measurement server 300 so that it can measure the capacity of the application server 100.

In order to measure the capacity, the user clients 200 use one of a PC, a PDA, a mobile telephone, and a terminal equipped with an Internet device and a computation device.

The capacity measurement server 300 transmits a capacity measurement program for applying loads to the application server 100 and a script, which describes a method and a procedure for generating loads, to the user clients 200. The capacity measurement server 300 receives a script execution command, which has been inputted by the administrator server 400, and transmits the command to the user clients 200. Based on the script, the capacity measurement server 300 collects information regarding the application program capacity of the application server 100 from the user clients 200 and analyzes the information. When a predetermined number of user clients 200 are necessary to measure the capacity of the application server 100, the capacity measurement server 300 checks whether or not respective clients can perform the test. In addition, the capacity measurement server 300 secures more clients than the predetermined number against a case in which some clients are forcibly terminated during the test.

This process will now be described with reference to an example.

It is assumed that 1,000 user clients are necessary to measure the capacity of the application server 100, and the user clients have a capacity measurement program installed therein. The capacity measurement server 300 selects 1,000 user clients from the user clients 200 that are supposed to participate in the capacity measurement and conducts the test. If the necessary number (1,000) cannot be reached due to abnormal termination of 100 user clients, the application server 100 additionally selects 100 clients so that they participate in the capacity test.

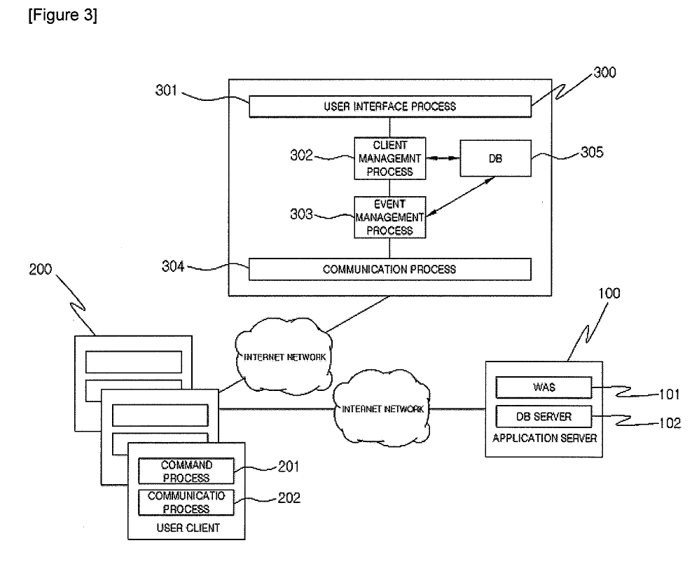

The capacity measurement server 300 conducts communication based on TCP/UDP/IP between the user clients 200. Between the application server 100 and the user clients 200, the capacity measurement server 300 uses a communication mode as required by the application program installed in the application server 100. Particularly, if the application program is a web service program, HTTP is used; if the application program is a database, TCP/IP-based SQL (Structured Query Language) is used; and, if software framework standardization is supported, XML (Extensible Markup Language) is used. In general, Internet-based TCP/UDP/IP communication is basically conducted between the user clients 200 and the application program. Furthermore, SIP and RTP are used for communication between a video telephone and an exchanger. Finally, the capacity measurement server 300 collects data regarding the test of the application server 100 from the user clients 200 and automatically composes a report containing the result of analysis of the capacity measurement. Based on the data from the user clients 200, the report contains items related to the capacity measurement, such as access condition, response time, and download time. The administrator client 400 provides the capacity measurement server 300 with a script execution command for testing the capacity of the application server 100. The administrator client 400 provides the user clients 200 with a script transmission command for testing the capacity of the application server 100. The administrator client 400 communicates with the capacity measurement server 300 by using HTTP (Hyper Text Transfer Protocol) or TCP/UDP/IP. The administrator client 400 displays the collection of data regarding the capacity of the application server 100, which has been measured according to the script, from the user clients 200, as well as the report from the capacity measurement server 300. FIG. 3 is a block diagram showing the construction of a system implementing a capacity measurement server and user clients according to the present invention. The capacity measurement server 300 includes a user interface process 301, a client management process 302, a message management process 303, a communication process 304, and a DB 305. Each user client 200 includes a communication process 201 and a command process 202. The application server 100 includes a WAS 101 and a DB server 102.

More particularly, when the administrator client 400 displays a means for inputting basic data necessary to measure the capacity and a means for clicking an execution button on the screen, the user interface process 301 of the capacity measurement server 300 exchanges data, which is inputted via the screen, with the administrator server 400.

In order to measure the capacity of the application server 100, the client management process 302 of the capacity measurement server 300 receives information regarding the condition of the CPU and memory from clients selected from the user clients 200 and manages the user clients 200. In addition, the client management process 302 generates a command to transmit a capacity measurement program so that the user clients 200 measure the capacity of the application server 100, as well as a command requesting that a script is executed by clients having the capacity measurement program installed therein. The resulting data is stored in the DB 305.

The message management process 303 of the capacity measurement server 300 executes a program and a relevant script. Particularly, the message management process 303 collects data regarding the capacity of the application server 100, which has been measured by the selected user clients 200 according to the script, and stores the data in the DB 305. Based on the stored data, the message management process 303 automatically composes a report regarding the result of capacity measurement. The report is transmitted to the administrator client 400 to be displayed.

The communication process 304 of the capacity measurement server 300 transmits a capacity measurement program, a script, etc. and collects capacity measurement data created by the user clients 200. The data is transmitted to the client management process 302 and the message management process 303. The DB 305 of the capacity measurement server 300 stores all data related to the capacity measurement.

The communication process 201 of the user clients 200 interworks with the communication process 304 of the capacity measurement server 300 so that the capacity measurement data collected by the command process 202 of the user clients 200 is transmitted to the capacity measurement server 300.

The command process 202 of the user clients 200 interworks with the application program of the application server 200 so as to execute the script as requested by the capacity measurement server 300, measure the capacity, and create capacity measurement data.

As such, the capacity measurement server 300 and the user clients 200 transmit the capacity measurement data by means of the communication process 201 and the command process 202 of the user clients 200. Particularly, the communication process 201 of the user clients 200 transmits the capacity measurement data to the communication process 304 of the capacity measurement server 300 as a message. The message management process 303 collects the transmitted data, analyzes it, and stores it in the DB 305.

The application server 100, as shown in FIG. 3, is not limited to a WAS and a DB server for handling connection requests of clients, data processing, and client management, but may be a measurement target selected from a softswitch, a media server, a game server, and a network management system server.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A grid computing system for testing an application program capacity of a server, the grid computing system comprising:
an application server having an application program installed therein;
a number of user clients having a capacity measurement program installed therein, the user clients applying a load, the load containing a scenario, to the application program so as to create capacity measurement data regarding the application server; and
a capacity measurement server for distributing a capacity measurement program to the user clients so as to transmit a load command, the capacity measurement server collecting the capacity measurement data created by the user clients and analyzing the capacity measurement data.

2. The grid computing system as claimed in claim 1, further comprising an administrator server for inputting commands to the capacity measurement server and displaying a capacity condition of the application server.

3. The grid computing system as claimed in claim 1, wherein the capacity measurement server and the user clients exchange the capacity measurement data as a message.

4. The grid computing system as claimed in claim 1, wherein the user clients are adapted to provide the capacity measurement server with the capacity measurement data based on a grid technique.

5. The grid computing system as claimed in claim 4, wherein the user clients are adapted to conduct capacity measurement by using one of a PC, a PDA, a mobile telephone, and a terminal equipped with an Internet device and a computation device.

6. The grid computing system as claimed in claim 4, wherein the capacity measurement data is created by a PC or a group of PCs establishing a small-scale network.

7. The grid computing system as claimed in claim 1, wherein the user clients and the application server communicate with each other by using one of HTTP, SQL, XML, TCP/UDP/IP, SIP, and RTP according to the application program of the application server.

8. The grid computing system as claimed in claim 1, wherein the capacity measurement server comprises:
a user interface process for interworking with the administrator client and receiving an execution command;
a client management process for managing the user clients so as to receive the execution command from the user interface process and conduct capacity measurement;
a message management process for receiving the capacity measurement data from the user clients, the user clients conducting capacity measurement, the message management process collecting and analyzing the capacity measurement data, the message management process composing a result report automatically; and
a communication process for receiving the capacity measurement data from the user clients.

9. The grid computing system as claimed in claim 1, wherein each user client comprises:
a communication process for interworking with the capacity measurement server; and
a command process for transmitting the capacity measurement data to the communication process, the capacity measurement data having been collected from the application server by the capacity measurement server.

10. The grid computing system as claimed in claim 1, wherein the application server is adapted to handle connection requests of clients, data processing, and client management, and the application server is a measurement target selected from a WAS, a softswitch, a media server, a game server, a network management system server, and a DB server.
